(19) United States
(12) Patent Application Publication
(10) Pub. No.: US 2018/0114460 A1
(43) Pub. Date: Apr. 26, 2018

(54) BOWLING FEEDBACK TRAINING DEVICE

(71) Applicant: Jimmie Rivera, JR., Gaithersburg, MD (US)

(72) Inventor: Jimmie Rivera, JR., Gaithersburg, MD (US)

(21) Appl. No.: 15/298,224

(22) Filed: Oct. 20, 2016

(51) Int. Cl. G09B 19/00; G09B 5/04

(52) U.S. Cl. CPC G09B 19/0038; G09B 5/04

(57) ABSTRACT

A bowling feedback training device including: at least one of A) a vibrating actuator, B) a skin stretch actuator, C) a skin pressure actuator, D) a tactile feedback device, E) and a speaker adapted to create an audible alert; at least one of a logic circuit designed to execute a control logic, and a processor coupled in communication to computer readable non-transitory storage medium that stores a control logic, where the at least one of a logic circuit adapted to execute a control logic and a processor coupled in communication to computer readable non-transitory storage medium that stores a control logic is coupled in communication to the at least one of A) a vibrating actuator, B) a skin stretch actuator, C) a skin pressure actuator, D) a tactile feedback device, E) and a speaker adapted to create an audible alert; at least one of I) a motion sensor, II) a position sensor, III) a gyroscopic sensor, and IV) an acceleration sensor coupled to the processor; a mount adapted to temporarily attach the at least one of I) a motion sensor, II) a position sensor, III) a gyroscopic sensor, and IV) an acceleration sensor to at least one of the user's arm, the user's wrist, and the user's hand, where the control logic is adapted to factor in the output of the at least one of I) a motion sensor, II) a position sensor, III) a gyroscopic sensor, and IV) an acceleration sensor to trigger activation output to at least one of A) a vibrating actuator, B) a skin stretch actuator, C) a skin pressure actuator, D) a tactile feedback device, E) and a speaker adapted to create an audible alert when at least one condition based on position, speed, acceleration, distance traveled, and time of traveled is met, where activating the at least one of A) a vibrating actuator, B) a skin stretch actuator, C) a skin pressure actuator, D) a tactile feedback device, E) and a speaker adapted to create an audible alert is adapted to provide feedback to the user on the user's bowling motion. The bowling feedback training device is preferably designed to help a user refine their bowling technique and achieve consistency that will help them improve their bowling game. The system of the preferred embodiments may, however, be used for any suitable purpose.

### BRIEF DESCRIPTION OF THE FIGURES

FIG. 1 is a schematic representation of the system of the first preferred embodiments

FIG. 2 is a schematic representation of the system of the first preferred embodiments, where the at least one of a logic circuit designed to execute a control logic, and a processor coupled in communication to computer readable non-transitory storage medium is shown.

### DESCRIPTION OF THE PREFERRED EMBODIMENTS

The description that follows of the invention's preferred embodiments is meant to enable someone skilled in the prior art to make and use the invention, but is not meant to limit the invention to these preferred embodiments.

### 1. First Preferred Embodiment

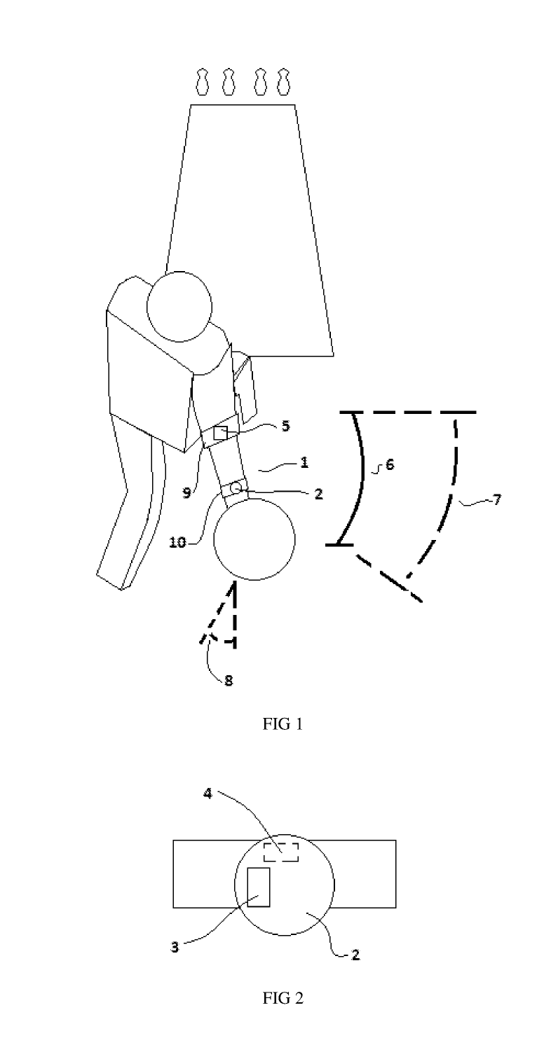

As shown in FIG. 1, the system of the preferred embodiments is a bowling feedback training device 1 including: at least one of A) a vibrating actuator 2, B) a skin stretch actuator 2, C) a skin pressure actuator 2, D) a tactile feedback device 2, E) and a speaker 2 adapted to create an audible alert; at least one of a logic circuit 3 designed to execute a control logic, and a processor 3 coupled in communication to computer readable non-transitory storage medium 4 that stores a control logic, where the at least one of a logic circuit 3 adapted to execute a control logic and a processor 3 coupled in communication to computer readable non-transitory storage medium 4 that stores a control logic is coupled in communication to the at least one of A) a vibrating actuator 2, B) a skin stretch actuator 2, C) a skin pressure actuator 2, D) a tactile feedback device 2, E) and a speaker 2 adapted to create an audible alert; at least one of I) a motion sensor 5, II) a position sensor 5, III) a gyroscopic sensor 5, and IV) an acceleration sensor 5 coupled to the processor 3; a mount adapted to temporarily attach the at least one of I) a motion sensor 5, II) a position sensor 5, III) a gyroscopic sensor 5, and IV) an acceleration sensor 5 to at least one of the user's arm, the user's wrist, and the user's hand, where the control logic is adapted to factor in the output of the at least one of I) a motion sensor 5, II) a position sensor 5, III) a gyroscopic sensor 5, and IV) an acceleration sensor 5 to trigger activation output to at least one of A) a vibrating actuator 2, B) a skin stretch actuator 2, C) a skin pressure actuator 2, D) a tactile feedback device 2, E) and a speaker 2 adapted to create an audible alert when at least one condition based on position, speed, acceleration, distance traveled, and time of traveled is met, where activating the at least one of A) a vibrating actuator 2, B) a skin stretch actuator 2, C) a skin pressure actuator 2, D) a tactile feedback device 2, E) and a speaker 2 adapted to create an audible alert is adapted to provide feedback to the user on the user's bowling motion. The bowling feedback training device 1 is preferably designed to help a user refine their bowling technique and achieve consistency that will help them improve their bowling game. The system of the preferred embodiments may, however, be used for any suitable purpose.

As shown in FIG. 1, the bowling feedback training device 1 includes at least one of A) a vibrating actuator 2, B) a skin stretch actuator 2, C) a skin pressure actuator 2, D) a tactile feedback device 2, E) and a speaker 2 adapted to create an audible alert, where the at least one of A) a vibrating actuator 2, B) a skin stretch actuator 2, C) a skin pressure actuator 2, D) a tactile feedback device 2, E) and a speaker 2 adapted to create an audible alert is designed to alert the user of a desired event. In a preferred variation, the desired event is related to data sensed by the at least one of I) a motion sensor 5, II) a position sensor 5, III) a gyroscopic sensor 5, and IV) an acceleration sensor 5. In a preferred variation, at least one of the position of the user's arm in the back swing, the length of time of the user's back swing, and the physical length 6 of the user's back swing is used as at least one condition for activating the at least one of A) a vibrating actuator 2, B) a skin stretch actuator 2, C) a skin pressure actuator 2, D) a tactile feedback device 2, E) and a speaker 2 adapted to create an audible alert. In a preferred variation of this variation, when at least one of these data measures reaches a desired quantity, at least one of A) a vibrating actuator 2, B) a skin stretch actuator 2, C) a skin pressure actuator 2, D) a tactile feedback device 2, E) and a speaker 2 adapted to create an audible alert is activated. In another preferred variation when at least one of these data measures surpasses a threshold quantity, at least one of A) a vibrating actuator 2, B) a skin stretch actuator 2, C) a skin pressure actuator 2, D) a tactile feedback device 2, E) and a speaker 2 adapted to create an audible alert is activated. In another preferred variation, at least one of the angle 7 of a user's back swing, and the rotation 8 of a user's hand is used as at least one condition for activating the at least one of A) a vibrating actuator 2, B) a skin stretch actuator 2, C) a skin pressure actuator 2, D) a tactile feedback device 2, E) and a speaker 2 adapted to create an audible alert. In a preferred variation of this variation, when at least one of these data measures reaches a desired quantity, at least one of A) a vibrating actuator 2, B) a skin stretch actuator 2, C) a skin pressure actuator 2, D) a tactile feedback device 2, E) and a speaker 2 adapted to create an audible alert is activated. In another preferred variation when at least one of these data measures surpasses a threshold quantity, at least one of A) a vibrating actuator 2, B) a skin stretch actuator 2, C) a skin pressure actuator 2, D) a tactile feedback device 2, E) and a speaker 2 adapted to create an audible alert is activated. These variations preferably allow the bowling feedback training device 1 to alert the user when at least one of their arm and their wrist at least one of meets and exceeds at least one of these quantities, which allows the user to react and adjust their bowling motion to make it more consistent, and to refine their bowling technique. Training using this device over time preferably greatly increases a user's skill and success at bowling. Preferably the bowling feedback training device 1 alerts the user of conditions indicating that their bowling swing motion is at least one of following the desired path, hitting the desired quantities, deviating from the desired path, and deviating from the desired quantities. There may, however, be any suitable outcome and usage method for the bowling feedback training device 1. The device may, however, use any suitable sensor 5 data, and alert the user in any suitable manner to any suitable condition.

As shown in FIG. 2, the bowling feedback training device 1 preferably includes at least one of a logic circuit 3 adapted to execute a control logic, and a processor 3 coupled in communication to computer readable non-transitory storage medium 4 storing a control logic. This allows the bowling feedback training device 1 to react to sensor 5 data in a desired way based on a control logic, allowing the bowling feedback training device 1 to activate at least one of A) a vibrating actuator 2, B) a skin stretch actuator 2, C) a skin pressure actuator 2, D) a tactile feedback device 2, E) and a speaker 2 adapted to create an audible alert at a desired condition based on sensor 5 data.

As shown in FIG. 1, in a preferred embodiment the bowling feedback training device 1 includes a strap 9 that is strapped near a user's elbow, where the strap 9 holds at least one of I) a motion sensor 5, II) a position sensor 5, III) a gyroscopic sensor 5, and IV) an acceleration sensor 5. This preferably allows data related to the user's elbow to be sensed. As shown in FIG. 2, in a preferred embodiment there is a wrist strap 10, where the wrist strap 10 is attached to at least one of A) a vibrating actuator 2, B) a skin stretch actuator 2, C) a skin pressure actuator 2, D) a tactile feedback device 2, E) and a speaker 2 adapted to create an audible alert. In another preferred variation, the wrist strap 10 also attaches to at least one sensor 5. In another preferred variation, there are at least two sensors 5 of any suitable type. In a preferred variation, there is only a wrist strap 10. In a preferred variation there is both a strap 9 near the user's elbow and a wrist strap 10. In a preferred variation there is only a strap 9 near the user's elbow. There may, however, be any suitable strap or combination of straps. There may also be any suitable means for attaching sensors and alert mechanisms to a user's arm, and there may not be any straps at all.

As a person skilled in the art will recognize from the previous detailed description and from the figures and claims, modifications and changes can be made to the preferred embodiments of the invention without departing from the scope of this invention defined in the following claims.

I claim:

1) A bowling feedback training device comprising: at least one of A) a vibrating actuator, B) a skin stretch actuator, C) a skin pressure actuator, D) a tactile feedback device, E) and a speaker adapted to create an audible alert; at least one of a logic circuit adapted to execute a control logic, and a processor coupled in communication to computer readable non-transitory storage medium storing a control logic, wherein the at least one of a logic circuit adapted to execute a control logic and a processor coupled in communication to computer readable non-transitory storage medium storing a control logic is coupled in communication to the at least one of A) a vibrating actuator, B) a skin stretch actuator, C) a skin pressure actuator, D) a tactile feedback device, E) and a speaker adapted to create an audible alert; at least one of I) a motion sensor, II) a position sensor, III) a gyroscopic sensor, and IV) an acceleration sensor coupled to the processor; a mount adapted to temporarily attach the at least one of I) a motion sensor, II) a position sensor, III) a gyroscopic sensor, and IV) an acceleration sensor to at least one of the user's arm, the user's wrist, and the user's hand, wherein the control logic is adapted to factor in the output of the at least one of I) a motion sensor, II) a position sensor, III) a gyroscopic sensor, and IV) an acceleration sensor to trigger activation output to at least one of A) a vibrating actuator, B) a skin stretch actuator, C) a skin pressure actuator, D) a tactile feedback device, E) and a speaker adapted to create an audible alert when at least one condition based on position, speed, acceleration, distance traveled, and time of traveled is met, wherein activating the at least one of A) a vibrating actuator, B) a skin stretch actuator, C) a skin pressure actuator, D) a tactile feedback device, E) and a speaker adapted to create an audible alert is adapted to provide feedback to the user on the user's bowling motion.

2) The bowling feedback training device of claim 1, wherein at least one of the position of the user's arm in the back swing, the length of time of the user's back swing, and the physical length of the user's back swing is used as at least one condition for activating the at least one of A) a vibrating actuator, B) a skin stretch actuator, C) a skin pressure actuator, D) a tactile feedback device, E) and a speaker adapted to create an audible alert.

3) The bowling feedback training device of claim 2, wherein when a desired quantity is reached for at least one of the position of the user's arm in the back swing, the length of time of the user's back swing, and the physical length of the user's back swing, the at least one of A) a vibrating actuator, B) a skin stretch actuator, C) a skin pressure actuator, D) a tactile feedback device, E) and a speaker adapted to create an audible alert is activated.

4) The bowling feedback training device of claim 2, wherein if the desired quantity is surpassed for at least one of the position of the user's arm in the back swing, the length of time of the user's back swing, and the physical length of the user's back swing, the at least one of A) a vibrating actuator, B) a skin stretch actuator, C) a skin pressure actuator, D) a tactile feedback device, E) and a speaker adapted to create an audible alert is activated, wherein this notifies the user that their back swing has reached an excessive value.

5) The bowling feedback training device of claim 1, wherein at least one of the angle of a user's back swing, and the rotation of a user's hand is used as at least one condition for activating the at least one of A) a vibrating actuator, B) a skin stretch actuator, C) a skin pressure actuator, D) a tactile feedback device, E) and a speaker adapted to create an audible alert.

6) The bowling feedback training device of claim 1, wherein if the quantity of at least one of the angle of a user's back swing, and the rotation of a user's hand exceeds an acceptable range of values, the at least one condition for activating the at least one of A) a vibrating actuator, B) a skin stretch actuator, C) a skin pressure actuator, D) a tactile feedback device, E) and a speaker adapted to create an audible alert is activated, wherein this activation provides the user feedback that their swing path is not what is desired.

7) The bowling feedback training device of claim 2, wherein at least one of the angle of a user's back swing, and the rotation of a user's hand is used as at least one condition for activating the at least one of A) a vibrating actuator, B) a skin stretch actuator, C) a skin pressure actuator, D) a tactile feedback device, E) and a speaker adapted to create an audible alert.

8) The bowling feedback training device of claim 3, wherein at least one of the angle of a user's back swing, and the rotation of a user's hand is used as at least one condition for activating the at least one of A) a vibrating actuator, B) a skin stretch actuator, C) a skin pressure actuator, D) a tactile feedback device, E) and a speaker adapted to create an audible alert.

9) The bowling feedback training device of claim 4, wherein at least one of the angle of a user's back swing, and the rotation of a user's hand is used as at least one condition for activating the at least one of A) a vibrating actuator, B) a skin stretch actuator, C) a skin pressure actuator, D) a tactile feedback device, E) and a speaker adapted to create an audible alert.

10) The bowling feedback training device of claim 7, wherein if the quantity of at least one of the angle of a user's back swing, and the rotation of a user's hand exceeds an acceptable range of values, the at least one condition for activating the at least one of A) a vibrating actuator, B) a skin stretch actuator, C) a skin pressure actuator, D) a tactile feedback device, E) and a speaker adapted to create an audible alert is activated, wherein this activation provides the user feedback that their swing path is not what is desired.

11) The bowling feedback training device of claim 8, wherein if the quantity of at least one of the angle of a user's back swing, and the rotation of a user's hand exceeds an acceptable range of values, the at least one condition for activating the at least one of A) a vibrating actuator, B) a skin stretch actuator, C) a skin pressure actuator, D) a tactile feedback device, E) and a speaker adapted to create an audible alert is activated, wherein this activation provides the user feedback that their swing path is not what is desired.

12) The bowling feedback training device of claim 9, wherein if the quantity of at least one of the angle of a user's back swing, and the rotation of a user's hand exceeds an acceptable range of values, the at least one condition for activating the at least one of A) a vibrating actuator, B) a skin stretch actuator, C) a skin pressure actuator, D) a tactile feedback device, E) and a speaker adapted to create an audible alert is activated, wherein this activation provides the user feedback that their swing path is not what is desired.

13) The bowling feedback training device of claim 1, further comprising a strap adapted to strap to the user's arm near the user's elbow, wherein the strap is attached to the at least one of I) a motion sensor, II) a position sensor, III) a gyroscopic sensor, and IV) an acceleration sensor.

14) The bowling feedback training device of claim 2, further comprising a strap adapted to strap to the user's arm near the user's elbow, wherein the strap is attached to the at least one of I) a motion sensor, II) a position sensor, III) a gyroscopic sensor, and IV) an acceleration sensor.

15) The bowling feedback training device of claim 3, further comprising a strap adapted to strap to the user's arm near the user's elbow, wherein the strap is attached to the at least one of I) a motion sensor, II) a position sensor, III) a gyroscopic sensor, and IV) an acceleration sensor.

16) The bowling feedback training device of claim 5, further comprising a strap adapted to strap to the user's arm near the user's elbow, wherein the strap is attached to the at least one of I) a motion sensor, II) a position sensor, III) a gyroscopic sensor, and IV) an acceleration sensor.

17) The bowling feedback training device of claim 13, further comprising a strap that is attached to the user's wrist, wherein the strap is attached to the at least one of A) a vibrating actuator, B) a skin stretch actuator, C) a skin pressure actuator, D) a tactile feedback device, E) and a speaker adapted to create an audible alert.

18) The bowling feedback training device of claim 14, further comprising a strap that is attached to the user's wrist, wherein the strap is attached to the at least one of A) a vibrating actuator, B) a skin stretch actuator, C) a skin pressure actuator, D) a tactile feedback device, E) and a speaker adapted to create an audible alert.

19) The bowling feedback training device of claim 15, further comprising a strap that is attached to the user's wrist, wherein the strap is attached to the at least one of A) a vibrating actuator, B) a skin stretch actuator, C) a skin pressure actuator, D) a tactile feedback device, E) and a speaker adapted to create an audible alert.
